(19) United States
(12) Patent Application Publication
(10) Pub. No.: US 2003/0092336 A1
(43) Pub. Date: May 15, 2003

(54) Durable and reusable multi-layer composite

(76) Inventors: Hugo Castro, Blackstock, SC (US); Thomas B. Hollingsworth, Orangeburg, SC (US)

Correspondence Address: BURNS, DOANE, SWECKER & MATHIS, L.L.P., P.O. Box 1404, Alexandria, VA, 22313-1404, US

(21) Appl. No.: 10/271,980

(22) Filed: Oct. 17, 2002

Related U.S. Application Data
(60) Provisional application No. 60/329,504, filed on Oct. 17, 2001.

(51) Int. Cl. B32B 5/02

(52) U.S. Cl. 442/59

(57) ABSTRACT

A multi-layer composite having a first layer including a cotton or poly-cotton blend, a second layer for absorbing moisture disposed adjacent the first layer; and a coating layer including a silicone coating applied to the second layer. The second layer includes a first surface and a second surface, with the first surface facing the first layer and the coating layer being applied to the second surface.

### CROSS-REFERENCE TO RELATED APPLICATION

This application claims priority under 35 U.S.C. §119 to U.S. Provisional Application No. 60/329,504, filed on Oct. 17, 2001, the entire content of which is hereby incorporated by reference.

### TECHNICAL FIELD

The present invention relates to a multi-layer composite, and more specifically, to a durable and reusable multi-layer composite that is particularly well suited for use as an incontinent underpad.

### BACKGROUND OF THE INVENTION

As the population in the United States and most other countries ages, increasingly large numbers of people world wide are hospitalized or spend long periods in convalescent care and nursing home facilities. The problem of incontinence in these seriously ill or elderly patients whether at home, in hospitals, or in nursing homes is well recognized by health care professionals. Many products have been developed and marketed for use in protecting patients' bedding from damage caused by absorption of urine and other fluids. Minimizing patient irritation and discomfort caused by prolonged exposure to absorbed fluids is also a concern of those caring for the patient. The present invention addresses two major problems faced by such institutional facilities and the home health care provider: (1) varying degrees of urinary incontinence experienced by a high percentage of patients; and (2) pressure sores, rashes, skin irritations, chafing, and other health problems resulting from prolonged confinement in bed.

Reusable underpads previously known in the industry suffer from a number of drawbacks. Traditionally, a bed pad of cotton fabric bonded to butyl rubber is used in hospitals and nursing care facilities. This type of rubber bed pad is waterproof, but it may still create undesirable health conditions. First, the cotton fibers absorb moisture into the structure of the fiber itself, and thus hold wetness next to the body. Second, the rubber does not allow the moisture underneath the patient's body to be wicked away from the skin or to readily evaporate.

Thus, the rubber bed pad, even when coated with cotton fibers, tends to prevent the dissipation of moisture from the body, and therefore contributes to a condition of uncomfortable warmth and perspiration. This may exacerbate a patient's discomfort and contribute to added perspiration wetness, for example, in cases of high fever. It is clear that moisture and lack of air flow are major contributing factors to pressure sores and other skin disorders associated with long-term confinement in bed.

Another significant problem in reusable pads currently available is durability to withstand exposure to the soap, bleach, alkalinity and high temperature of the wash and dry cycles in an industrial or institutional laundry. It must be recognized that home wash conditions are much milder. For a valid comparison as to durability, competitive pads must be washed under the same conditions. Currently available products suffer significant breakdown at 100 washings or less. Similarly, the various combinations of materials and bonding techniques used on the prior art have not resulted in optimum performance characteristics.

In view of the problems associated with reusable rubber pads, disposable underpads are also currently used by many institutions. These pads are relatively expensive, however, and do not provide optimum comfort and absorption because of the types of materials that must be used. Consequently multiple pads are used under the patient at each change which gives better protection to the bedding but does little to aid patient comfort. Furthermore, with the ever increasing environmental concerns associated with disposable products, a reusable product would be preferable.

Ideally, in a reusable incontinent pad the surface of the top fabric of the composite, that portion against the skin, should have a soft comfortable texture and aid in conducting fluid into the interior of the structure. The absorbent middle layer should spread and contain the fluid. The bottom layer should not slide on the bed, making it difficult to keep the pad in position and the whole structure should be strong enough to support the weight of the patient since nurses often use the underpads to turn the patient. The bottom layer is also the barrier, and it should not allow fluid to pass through it into the bed linens underneath.

### SUMMARY OF THE INVENTION

The present invention overcomes the disadvantages of the prior art rubber bed pads and strives to satisfy the ideal requirements for a reusable incontinent pad. The multi-layer composite of the present invention is particularly well suited for use as an incontinent underpad and is designed to create a healthier, dry environment next to a patient's body by managing and protecting the bedding or other support surface from moisture arising from urinary leakage, exudates, or the like.

In a preferred embodiment, the present invention provides a multi-layer composite comprising a first layer including a cotton or poly-cotton blend, a second layer for absorbing moisture disposed adjacent the first layer; and a coating layer comprising a silicone coating applied to the second layer. The second layer includes a first surface and a second surface, with the first surface facing the first layer and the coating layer being applied to the second surface. Preferably, the silicone coating comprises an approximately 100 percent silicone elastomer having a high viscosity of approximately 15,000 to 25,000 cps.

A further embodiment of the present invention provides a multi-layer composite comprising a first layer including a woven cotton or poly-cotton blend; a second layer for absorbing moisture disposed adjacent the first layer, with the second layer comprising a non-woven polyester; and a coating layer comprising a liquid impermeable barrier coating applied to the second layer.

### BRIEF DESCRIPTION OF THE DRAWINGS

The preferred embodiments of the present invention will be described in greater detail with reference to the accompanying drawings, wherein like members bear like reference numerals and wherein:

FIG. 1 is a multi-layer composite according to a preferred embodiment of the present invention.

FIG. 2 is a cross-sectional view thereof.

### DESCRIPTION OF THE PREFERRED EMBODIMENTS

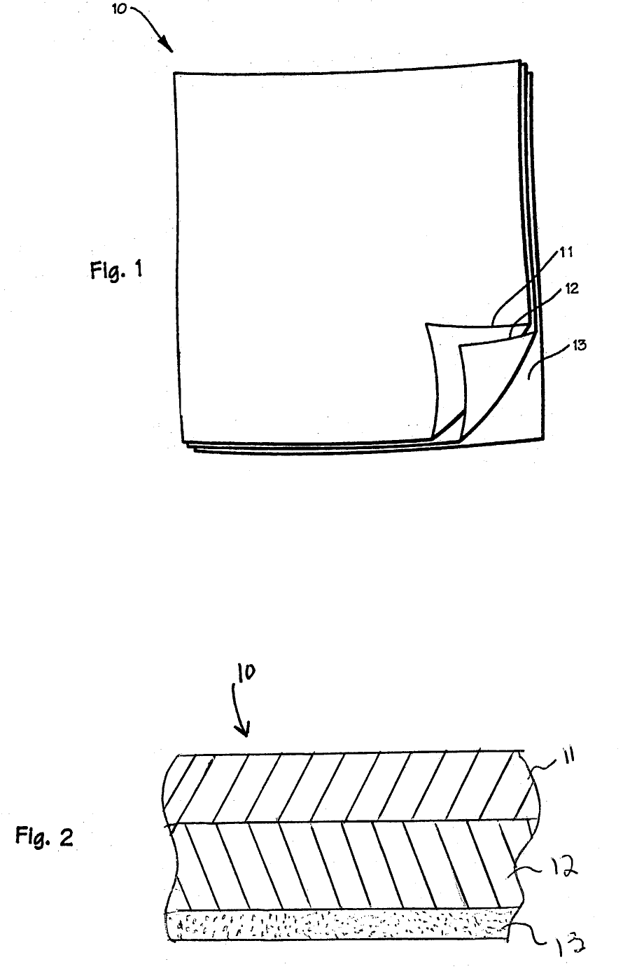

Referring now to the drawings, a multi-layer composite according to the present invention is illustrated in FIG. 1 and shown generally by reference numeral 10. According to a preferred embodiment, the composite 10 includes top layer 11, intermediate layer 12, and a bottom coating layer 13.

The top layer 11 is the uppermost fabric layer of the composite 10, the outer side of the layer 11 being that which resides in direct contact with the body of the patient. The top layer 11 is preferably formed from cotton or a poly-cotton blend, such as a woven 100 percent cotton material or a woven 30/70 cotton/polyester material. It is possible for a non-woven material also to be used for the top layer 11. Other materials which could be used to form the top layer 11 include terry cloth or brush polyester, for example. Still further, the top layer 11 may be formed from two fabric layers. An example of such a two fabric construction would be a non-absorbent hydrophobic layer, such as a lightweight, breathable non-woven material, which resides in contact with the patient's body or skin to effectively transport or wick moisture away from the body, and an absorbent hydrophillic layer, such as a woven or non-woven, which draws fluid inwardly to the intermediate layer 12. The top layer 11 should have a comfortable surface for contact with a user's skin.

The top layer 11 may if desired be screen printed to provide an appealing design to the surface of the composite 10. Still further, the top layer 11 may be treated with a variety of chemicals, such as, for example, a hydrophobic coating, an anti-microbial agent, an anti-dust mite agent, a fire-retardant coating and/or a stain resistance coating, provided that said chemicals do not adversely effect the overall properties of the top layer 11 or the composite 10. Alternatively, these additional chemical treatments may be applied after the finished composite has been manufactured or the additives may be mixed in the bottom layer coating 13, described further below, before the application thereof to the intermediate layer 12.

The intermediate fabric layer 12 resides adjacent to and in surface contact with the inner face of the top fabric layer 11. The intermediate layer 12 is constructed of hydrophilic fibers, and thus acts to further receive and disperse moisture wicked inwardly from the top fabric layer 11. Moreover, the intermediate fabric layer 12 functions as a reservoir for holding substantial quantities of moisture. This serves to enhance the overall ability of the composite 10 to maintain a relatively dry fabric surface next to the body of the patient. Preferably, the intermediate layer 12 is formed from a non-woven 100 percent polyester, preferably one that has been pre-treated by calendering, although a non-woven cotton, non-woven rayon, or blends thereof would also be suitable. In a preferred embodiment, the intermediate batting layer 12 has a weight of approximately 9.5 ounces/square yard and a thickness of approximately 0.065 inch; however, the weight and thickness of the material layer could be greater or lesser depending upon the intended end use. The intermediate layer 12 may also include superabsorbents to increase the absorption capabilities thereof.

The bottom coating 13 is preferably formed from 100 percent silicone such that the bottom surface of the composite 10 is waterproof or liquid impermeable. The bottom fabric layer 13 is designed to provide a leak-proof barrier which protects the bedding from liquid. The silicone is also successful in providing a non-slip surface and, since it is inert, it is not likely to cause skin irritations. Other materials which may be used to form the bottom coating layer 13 include a polyurethane coating, polyvinylchloride (PVC) film, neoprene latex, water-based epoxy and styrene acrylic polymers. Any desired additives, fillers, pigments, or the like may be added to the coating prior to its application to the intermediate layer 12.

One of the preferred formulations of the bottom coating 13 is an elastomer product having a high viscosity, on the order of about 15,000 cps to 25,000 cps. An example of such a silicone elastomer is SLE5400 available from GE Silicones. SLE 5400 is a liquid, two component silicone elastomer. Component A of SLE5400 (SLE5400A) is approximately 60-80 wgt. % vinylpolydimethylsiloxane, 10-30 wgt. % vinyl containing resin, and 5-10 wgt. % silica, ((trimethylvinylsilyl)oxy) and ((trimethylsilyl)oxy)-modified. Component B of SLE5400 (SLE5400B) is approximately 60-80 wgt. % vinylpolydimethylsiloxane, 10-30 wgt. % vinyl containing resin, and 1-5 wgt. % gamma-glycydoxypropyltrimethoxysiln, which is a catalyst. The viscosity of both components at 25° C. is 25,000 cps. The catalyzed viscosity at 25° C. after 6 hours is 250,000 cps. The specific gravity at 25° C. is 1.01 and the worklife at 25° C. is 8 hours. Typical cured properties of SLE 5400 after 1 hour at 150° C. are a Shore A hardness of 48, a tensile strength of 800 psi and 200% elongation.

Most preferably, SLE5400 is utilized as the base coating in coating layer 13, and one or more additional coatings is applied thereover. The additional coatings may also be SLE5400, or may include the other materials which may be used to form the bottom coating layer 13, including a polyurethane coating, polyvinylchloride (PVC) film, neoprene latex, water-based epoxy and styrene acrylic polymers. More preferably, SLE5300 also available from GE Silicones may be used to form a second coating on the base coating. SLE5300 is a liquid, two component silicone elastomer. Component A of SLE5300 (SLE5300A) is approximately 10-30 wgt. % calcium carbonate and 60-80 wgt. % vinylpolydimethylsiloxane. Component B of SLE5300 (SLE5300B) is approximately 30-60 wgt. % polymethylhydrogensiloxane and 60-80 wgt. % vinylpolydimethylsiloxane. The viscosity of the components A and B of SLE5300 at 25° C. are 26,000 cps and 1,200 cps, respectively. The specific gravity at 25° C. is 1.17 and the worklife at 25° C. is 48 hours. Typical cured properties of SLE5300 after 1 hour at 150° C. are a Shore A hardness of 33.

When using a base coating of SLE5400 and one additional coating of SLE5300 in the manufacture of the preferred embodiment, the total weight of the bottom coating 13 is approximately 4-6 ounces/square yard.

Other silicone elastomers having similar properties to those discussed above include Elastosil LR 6285A available from Wacker Silicones Coporation, Adrian, Mich.; Rhodorsil TCS 7050 A available from Rhodia Inc., Cranbury, N.J.; and Dow Corning(R) 3730, available from Dow Corning, Midland, Mich., and having a Part A which is approximately 15-40 wgt. % dimethylvinylated and trimethylated silica and 0.1 -1.0 wgt. % octamethylcyclotetra-siloxane and a Part B which is approximately 15-40 wgt. % dimethylvinylated and trimethylated silica, 10-30 wgt. % dimethyl, methylhydrogen siloxane, and 0.1-1.0 wgt. % octamethylcyclotetra-siloxane. Other possible silicones may include those disclosed in U.S. Pat. Nos. 5,904,988, 6,107,381, and 6,107,434, the entire contents of which are incorporated by reference.

The bottom coating 13 preferably provides a fireproof, durable surface which is capable of withstanding extreme temperatures. The resulting surface on the composite 10 is also an anti-skid surface which assists in preventing the composite 10 from sliding on a bed when the composite 10 is used as an incontinent pad, or another support surface when used elsewhere.

In manufacture of the composite 10, the coating layer 13 is preferably applied to an outer surface of the intermediate layer 12 in a two coat application using a knife coating technique, although a one coat application using a knife coating technique and/or a spray coating or other application technique could also be used. More particularly, a coating of PVA, PVC, or other coating material may first be sprayed on to an outer surface of the intermediate layer 12, and a one pass coating of the silicone elastomer may then be applied thereover using a knife coating. The inner surface of the intermediate layer 12 (opposite from the coating layer 13) is then preferably laminated to the inner surface of the top layer 11 (opposite from any screen printed design), preferably using a hot melt web such as polyamide or the like. The fabric layers 11, 12 could also be attached by ultrasonic welds formed by an ultrasonic heat applicator, or any other conventional means such as radio frequency, stitching, heat sealing, or the like, provided that such may be implemented without adversely effecting the material layers 11, 12 or the coating 13. When cut to a predetermined size, preferably around 36 inches by 30 inches, the composite 10 can be further finished along its perimeter either by sewing the side edges of the layers together using an over-edge or other standard stitch formation, or by heat sealing or ultrasonic bonding, or any other conventional seaming means. The overall thickness of the composite 10 is preferably, according to the preferred embodiment described above, approximately 0.080 inch, although the thickness could be greater or lesser depending upon the particular end use.

The multi-layer composite 10 of the present invention forms a reusable and durable construction suitable for many uses. As an example of the durability of the composite 10, the present invention has been tested to withstand approximately 250 launderings under the standardized commercial wash test 4-A (AATTCC 61-1996 (4A), without delamination or degradation of the silicone coating layer. Such a wash test is performed at approximately 160° C. with Chlorine and detergent and 100 steel balls within the wash tub. Despite these extreme conditions, the silicone coating of layer 13 has been found to have superior adhesion to the underlying intermediate layer 12 due in part to the stable nature of the silicone and the fact that it does not decompose at high temperatures.

Other potential uses of the composite 10, according to the present invention, include wheelchair pads, furniture or other support surface underpads for protecting the same from soiling, pads for operating tables, pads for infant cribs, pads for truck drivers, buses and automobiles, operators of heavy equipment, and others who sit for long periods on vinyl or rubberized surfaces. Other uses would also include pads or bedding for dogs and cats, or other animals. Still further, the composite of the present invention may have certain architectural advantages in acoustical liners, insulation panels or the roofing industry.

The present invention has now been described with reference to several embodiments thereof. The foregoing detailed description has been given for clarity and understanding only. No unnecessary limitations are to be understood therefrom. It will be apparent to those skilled in the art that many changes can be made in the embodiments described without departing from the scope of the invention. Thus, the scope of the present invention should not be limited to the exact details and structures described herein, but rather by the structures described by the language of the claims, and the equivalents of those structures.

1. A multi-layer composite comprising:
a first layer including a cotton or poly-cotton blend;
a second layer for absorbing moisture disposed adjacent said first layer; and
a coating layer comprising a silicone coating applied to said second layer.

2. The multi-layer composite of claim 1, wherein said second layer includes a first surface and a second surface, the first surface facing said first layer and said coating layer being applied to the second surface.

3. The multi-layer composite of claim 1, wherein the silicone coating comprises approximately 100 percent silicone.

4. The multi-layer composite of claim 3, wherein the silicone coating comprises a silicone elastomer.

5. The multi-layer composite of claim 4, wherein the silicone elastomer has a high viscosity of approximately 15,000 to 25,000 cps.

6. The multi-layer composite of claim 5, wherein the silicone coating comprises a liquid, two component silicone elastomer, a first component being approximately 60-80 wgt. % vinylpolydimethylsiloxane, 10-30 wgt. % vinyl containing resin, and 5-10 wgt. % silica, ((trimethylvinylsilyl)oxy) and ((trimethylsilyl)oxy)-modified, and a second component being approximately 6080 wgt. % vinylpolydi-methylsiloxane, 10-30 wgt. % vinyl containing resin, and 15 wgt. % gamma-glycydoxypropyltrimethoxysiln, which is a catalyst.

7. The multi-layer composite of claim 4, wherein said coating layer comprises a single coat application.

8. The multi-layer composite of claim 4, wherein said coating layer comprises a two coat application, a first coating comprising the silicone coating and a second coating.

9. The multi-layer composite of claim 8, wherein the second coating comprises a material different from the first coating.

10. The multi-layer composite of claim 4, wherein the silicone coating comprises a two component silicone elastomer having a Part A which is approximately 15-40 wgt. % dimethylvinylated and trimethylated silica and 0.1-1.0 wgt. % octamethylcyclotetra-siloxane and a Part B which is approximately 15-40 wgt. % dimethylvinylated and trimethylated silica, 10-30 wgt. % dimethyl, methylhydrogen siloxane, and 0.1-1.0 wgt. % octamethylcyclotetra-siloxane.

11. The multi-layer composite of claim 1, wherein said first layer comprises a woven approximately 100 percent cotton material.

12. The multi-layer composite of claim 1, wherein said first layer comprises a woven 30/70 cotton/polyester material.

13. The multi-layer composite of claim 1, wherein said first layer comprises a first fabric layer and a second fabric layer.

14. The multi-layer composite of claim 14, wherein said first fabric layer comprises a non-absorbent hydrophobic layer and the second fabric layer comprises an absorbent hydrophillic layer.

15. The multi-layer composite of claim 1, wherein said second fabric layer comprises a non-woven, approximately 100 percent polyester material.

16. The multi-layer composite of claim 1, wherein said second fabric layer includes superabsorbents.

17. The multi-layer composite of claim 1, wherein said multi-layer composite comprises an incontinent underpad.

18. A method of manufacturing a multi-layer composite comprising:
coating a first surface of an absorbent layer with a liquid impermeable barrier coating; and
joining a second surface of the absorbent layer to a first material layer;
wherein said coating step includes applying a silicone elastomer to the absorbent layer with a knife coating technique.

19. The method of manufacturing of claim 18, wherein said coating step further includes spraying a first coating on the first surface of the absorbent layer before applying the silicone elastomer with the knife coating technique.

20. A multi-layer composite comprising:
a first layer including a woven cotton or poly-cotton blend;
a second layer for absorbing moisture disposed adjacent said first layer, said second layer comprising a non-woven polyester; and
a coating layer comprising a liquid impermeable barrier coating applied to said second layer.
